(19) United States
(12) Patent Application Publication
(10) Pub. No.: US 2012/0052160 A1
(43) Pub. Date: Mar. 1, 2012

(54) DAIRY PRODUCT AND PROCESS

(76) Inventors: Rizana Imtiaz, Palmerston North (NZ); Stephen Gregory, Palmerston North (NZ); Qing Low, Palmerston North (NZ)

(21) Appl. No.: 13/095,794

(22) Filed: Apr. 27, 2011

Related U.S. Application Data
(63) Continuation-in-part of application No. PCT/NZ2010/000212, filed on Oct. 21, 2010.
(60) Provisional application No. 61/254,124, filed on Oct. 22, 2009.
(60) Provisional application No. 61/312,170, filed on Mar. 9, 2010.

(51) Int. Cl. A23C 21/06; A23J 3/10; A23P 1/16

(52) U.S. Cl. 426/87; 426/564; 426/474; 426/572; 426/559

(57) ABSTRACT

The present invention relates to a foamable composition that comprises calcium-depleted casein and whey protein that can be whipped to produce a foam having (a) good foaming properties, (b) good heat set properties, or (c) good foaming and heat set properties. The invention also relates to a method of making a foam comprising the steps of (1) providing calcium-depleted casein and whey protein, (2) mixing the foamable composition with a source of water so that the protein concentration in the foamable composition is about 1 to about 25% w/w, and (3) whipping the mixture to a foam, wherein a source of water is added to the calcium-depleted casein or the whey protein or is added to the mixture prior to, or during, being whipped.

### REFERENCE TO RELATED APPLICATIONS

This application is a Continuation-in-Part of International Application PCT/NZ2010/0002121, filed Oct. 21, 2010, and claims priority to U.S. Provisional Applications 61/254,124, filed Oct. 22, 2009, and 61/312,170, filed Mar. 9, 2010. Each of the priority applications is hereby incorporated by reference in its entirety.

### FIELD OF THE INVENTION

The present invention relates to a dairy-based foamable composition, its use, and methods of preparing a formulation thereof. More particularly it relates to a foam ingredient formed from calcium-depleted casein and whey protein.

### BACKGROUND

Egg white has good viscosity and heat set properties that have led to its use in cooking and baking, specifically as an ingredient in aerated confectionary and baked goods. Currently there is no useful, widely accepted alternative to egg white. While whey proteins and caseinates are well known as foaming agents, neither of these ingredients have good heat set properties, good stability, nor good viscosity resulting in their unsuitability as a replacer of egg white in cooking and baking.

It is an object of the present invention to provide a dairy-based foamable composition that can be used as an alternative to egg white, has good heat set properties, good stability and good viscosity, that overcomes or at least ameliorates at least one of the abovementioned disadvantages, or that at least provides the public with a useful choice.

### SUMMARY OF THE INVENTION

Accordingly, in a first aspect the present invention relates to a foamable composition that comprises calcium-depleted casein and whey protein, wherein the foamable composition can be whipped to produce a foam having (a) good foaming properties, (b) good heat set properties, or (c) good foaming and heat set properties.

Another aspect of the invention relates to a foamable composition that comprises calcium-depleted casein and whey protein, and when mixed with a source of water the foamable composition can be whipped to produce a foam having (a) good foaming properties, (b) good heat set properties, or (c) good foaming and heat set properties.

Another aspect of the invention relates to a foamable composition comprising between about 1 to about 25% w/w protein, wherein the foamable composition comprises calcium-depleted casein and whey protein, and wherein the foamable composition can be whipped to produce a foam having (a) good foaming properties, (b) good heat set properties, or (c) good foaming and heat set properties.

Accordingly, in a first aspect the present invention relates to a foamable composition that comprises calcium-depleted casein, whey protein and sugar, wherein the foamable composition can be whipped to produce a foam having (a) good foaming properties, (b) good heat set properties, or (c) good foaming and heat set properties.

Another aspect of the invention relates to a foamable composition comprising (i) between about 1 to about 25% w/w protein, and (ii) sugar, wherein the foamable composition comprises calcium-depleted casein and whey protein, and wherein the foamable can be whipped to produce a foam having (a) good foaming properties, (b) good heat set properties, or (c) good foaming and heat set properties.

Another aspect of the invention relates to a method of making a foam comprising the steps of
(1) providing a foamable composition comprising calcium-depleted casein and whey protein,
(2) mixing the foamable composition with a source of water so that the protein concentration in the foamable composition is about 1 to about 25% w/w, and
(3) whipping the foamable composition to a foam.

Another aspect of the invention relates to a method of making a foam comprising the steps of

(1) providing calcium-depleted casein and whey protein,

(2) mixing the calcium-depleted casein and whey protein, and

(3) whipping the mixture

wherein a source of water is added to the calcium-depleted casein or the whey protein or is added to the mixture prior to, or during, being whipped.

Another aspect of the invention relates to a method of making a foam comprising the steps of

(1) providing calcium-depleted casein and whey protein,

(2) mixing the calcium-depleted casein and whey protein, and

(3) whipping the mixture

wherein the calcium-depleted casein and whey protein mixture is at least partially hydrated prior to, or during, being whipped.

Another aspect of the invention relates to a method of making a food product comprising the steps of
(1) providing a whipped foamable composition that comprises calcium-depleted casein and whey protein, and
(2) mixing a heated sugar syrup substantially free of sucrose with the foamable composition, wherein the food product has a nougat-like texture with minimal crystallisation.

Another aspect of the invention relates to a food product comprising a foamable composition of the present invention.

Another aspect of the invention relates to a kit comprising calcium-depleted caseinate and whey protein, wherein the kit provides instructions to mix the calcium-depleted casein, whey protein and water to form a foamable composition, so that the foamable composition comprises about 1 to about 25% w/w protein, and whip the foamable composition to a foam.

The following embodiments may relate to any of the above aspects.

In one embodiment the calcium-depleted casein is a calcium-depleted milk protein concentrate.

In one embodiment the calcium-depleted casein is a calcium-depleted caseinate.

In one embodiment the whey protein is selected from

cheese whey,

sweet whey,

acid (lactic or mineral) whey,

whey protein concentrate,

whey protein isolate,

whey protein concentrate and whey protein isolate, and

a combination of any of the above.

In some embodiments the ratio of the calcium-depleted casein to whey protein in the foamable composition is about 3:1, 3:1.5, 3:2, 3:2.5, 3:3, 2.5:3, 2:3, 1.5:3 or 1:3.

In some embodiments the ratio of the calcium-depleted casein to whey protein in the foamable composition is about 75:25, 66:33, 60:40, 55:45, 50:50, 45:55, 40:60, 33:66 or 25:75%.

In some embodiments the foamable composition is a liquid.

In some embodiments the foamable composition is a powder.

In some embodiments the foamable composition is a solid form.

In some embodiments the sugar is from a sugar syrup.

In some embodiments the sugar syrup is added to the foamable composition after the foamable composition is whipped.

In some embodiments the sugar syrup is added to the foamable composition before the foamable composition is whipped.

In some embodiments the foamable composition comprises at whipping about 15, 16, 17, 18, 19, 20, 21, 22, 23, 24 or 25% w/w total protein.

In some embodiments the foamable composition comprises about 25, 30, 35, 40, 45, 50, 55, 60, 65, 70 or 75% of calcium-depleted casein relative to the total amount of protein provided by the calcium-depleted casein and whey protein. That is, about 25 to about 75% of the protein present in the foamable composition is from the calcium-depleted casein.

In some embodiments the foamable composition comprises about 25, 30, 35, 40, 45, 50, 55, 60, 65, 70 or 75% whey protein relative to the total amount of protein provided by the calcium-depleted casein and whey protein. That is, about 25 to about 75% of the foamable composition is from whey protein.

In some embodiments the foamable composition is whipped using shear. Preferably high the foamable composition is whipped using high shear force. Preferably a Hobart or bear mixer is used.

In some embodiments the overrun of the foamable composition is 200, 300, 400, 500, 600, 700, 800, 900, 1000, 1100, 1200, 1300, 1400 or 1500%.

In some embodiments the foam expansion of the foamable composition is up to 10, 20, 30, 40 or 50%.

In some embodiments, the method comprises an initial step of mixing the calcium-depleted casein and whey protein to form the foamable composition.

In another embodiment, the method comprises, before the whipping step, a step of hydrating the foamable composition, the calcium-depleted casein, or the whey protein.

In some embodiments the foamable composition is at least partially hydrated prior to the foamable composition being whipped.

In some embodiments the foamable composition is fully hydrated prior to the protein foamable composition whipped.

In another embodiment, the method comprises, before the whipping step, a step of mixing water and the calcium-depleted casein, or the whey protein, or the calcium-depleted casein and the whey protein.

In some embodiments the source of calcium-depleted casein and whey protein are dry blended prior to hydration. Preferably the whipping occurs after the foamable composition mixture is mixed with water to about 1 to about 25% w/w protein.

In some embodiments the calcium-depleted casein and whey protein are dry blended prior to mixing with water.

In some embodiments the calcium-depleted casein is mixed with a source of water prior to mixing with the dry whey protein. Preferably the foamable composition mix is further mixed with a source of water prior to whipping.

In some embodiments the whey protein is mixed with a source of water prior to mixing with the source of dry calcium-depleted casein. Preferably the protein mixture is further mixed with a source of prior to whipping.

In some embodiments the calcium-depleted casein and whey protein are wet blended prior to whipping, or prior to mixing with a source of water and whipping.

In some embodiments the hydrated or partially hydrated mixture is dried.

In some embodiments the wetted or partially wetted mixture is dried.

In some embodiments the foamable composition is hydrated for about 15, 20, 25, 30, 35, 40, 45, 50, 55, or 60 min.

In some embodiments the foamable composition is hydrated at about 20, 25, 30, 35, 40, 45, 50, 55 or 60° C.

In some embodiments the foamable composition is whipped with high shear force for 3, 4, 5, 6 7, 8, 9, or 10 min.

In some embodiments the whipped foamable composition has high viscosity. Preferably the viscosity of the whipped protein is between about 280,000 to about 450,000 cP. More preferably the viscosity of the whipped protein is between about 320,000 to about 400,000 cP.

In some embodiments the whipped foamable composition has high stability.

In some embodiments the foamable composition comprises any one or more of the following additives:

carbohydrate,

carbohydrate syrup,

whey protein,

flavour,

thickener,

salt,

acid,

alkali,

stabiliser, and

gum.

In some embodiments the carbohydrate is a sugar, a fiber, poly-dextrose, or a sugar alcohol.

In some embodiments the calcium-depleted casein and whey protein mixture forms a protein concentrate.

In some embodiments the food product is a confectionary or a baked good.

In some embodiments the product is a nougat or nutritional bar.

In some embodiments the syrup comprises a non-sucrose sugar and glycerine.

In some embodiments the non-sucrose sugar is glucose. Preferably the ratio of glucose to glycerine is from about 1:1 to about 8:1 glucose to glycerine. More preferably the ratio of glucose to glycerine is from about 2:1 to about 6:1.

In some embodiments the non-sucrose sugar is glucose. Preferably the ratio of glucose to glycerine is from about 50%:50% to about 90%:10% glucose to glycerine. More preferably the ratio of glucose to glycerine is from about 66%:33% to about 85%:15%.

In one embodiment the syrup is heated to about at least 60, 65, 70, 75, 80, 85, 90 or 95° C.

In some embodiments additional whey is added to the foamed protein concentrate. Preferably the additional whey is WPC (whey protein concentrate), WPI (whey protein isolate) or a mixture of WPC and WPI.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

### BRIEF DESCRIPTION OF THE DRAWINGS

FIG. 1A is a photo that shows the heat set properties of egg white at 10% protein with added hot sugar syrup.

FIG. 1B is a photo that shows the heat set properties of MPC (81% protein; 90% calcium depletion) (a calcium-depleted MPC) at 10% protein with added hot sugar syrup.

FIG. 1C is a photo that shows the heat set properties of WPI (94% protein) at 10% protein with added hot sugar syrup.

FIG. 2 is a graph showing the effect of protein concentration on foam volume using MPC (81% protein; 90% calcium depletion). The dotted line show the egg white benchmark at 20 min in room temperature. Foam volume decreases with increasing protein concentration with 11% protein showing the closest result to the egg white benchmark.

FIG. 3 is a graph showing the effect of protein concentration on foam viscosity using MPC (810% protein; 90% calcium depletion). The dotted line show the egg white benchmark at 20 min in room temperature. Foam viscosity increases with increasing protein concentration with 15% protein showing the closest result to the egg white benchmark.

FIG. 4A shows the heat set properties of egg white at 20% protein with added hot sugar syrup.

FIG. 4B shows the heat set properties of MPC (81% protein; 90% calcium depletion) at 10.5% protein with added hot sugar syrup.

FIG. 5A shows the heat set properties of egg white at 20% protein with added hot sugar syrup.

FIG. 5B shows the heat set properties of a calcium-depleted MPC/WPC blend at 20% protein with added hot sugar syrup.

### DETAILED DESCRIPTION OF THE INVENTION

The foamable composition is suitable for use in foods, and particularly as a substitute for foaming ingredients such as egg white. The invention relates to the preparation and use of a foamable protein concentrate that comprises calcium-depleted casein and whey protein.

In an alternate embodiment the foamable composition is prepared from protein selected from calcium-depleted casein and whey protein without drying prior to hydration (if needed). It should be appreciated that the hydration step, as a separate step, is not required where, for example, wet blending of the calcium-depleted casein and whey protein has taken place. i.e. where the calcium-depleted casein and whey protein have been wet blended and are in a sufficiently hydrated state, once blending has been effected the blended protein concentrate can then be whipped.

In an alternate embodiment the foamable composition is prepared from protein comprising calcium-depleted casein and whey protein without drying. It should be appreciated that the water can be sourced from any liquid mixture, such as for example a sugar syrup or water already present in the calcium-depleted casein or whey protein.

In one embodiment the foamable composition is dried and is supplied as an ingredient for subsequent mixture with water or hydration, and whipping when used in a recipe for a food product, such as a confectionary or baked good, as a replacer of egg white.

1.1 Definitions

The term “calcium-depleted casein” is a milk protein in which at least some of the calcium ions are substituted with another metal ion, preferably another monovalent ion

The term “comprising” as used in this specification and claims means “consisting at least in part of”. When interpreting statements in this specification and claims which include that term, the features, prefaced by that term in each statement or claim, all need to be present but other features can also be present. Related terms such as “comprise” and “comprised” are to be interpreted in the same manner.

As used herein the terms glycerine, glycerin and glycerol are interchangeable.

The term “good foaming property”, and its derivatives, means a foam having foam volume, viscosity and stability similar to that of egg white. Preferably the foam volume characteristic of a foamed product of the present invention is from about 75 to about 150% of that of egg white, and more preferably from about 80 to about 125%. Preferably the viscosity characteristic of a foamed product of the present invention is from about 75 to about 150% of that of egg white, and more preferably from about 80 to about 125%. Preferably the stability characteristic of a foamed product of the present invention is from about 75 to about 150% of that of egg white, and more preferably from about 80 to about 125%.

The term “good heat set property”, and its derivatives, means that the foam protein forms a thermoset or coagulum gel similar to that of egg white. Preferably the heat set characteristic of a foamed product of the present invention is from about 75 to about 150% of that of egg white, and more preferably from about 80 to about 125%.

The term “high stability” when applied to a foam means that the foam drip is less than about 10 ml, preferably less than about 8 ml and more preferably less than about 7 ml per hour.

The term “hydrated” means that the substance (i.e. protein concentrate) contains water. Preferably the substance contains at least about 70 to about 85% water, and more preferably at least about 75 to about 85% water.

The term “milk protein concentrate” (MPC) refers to a milk protein product in which greater than 40%, preferably greater than 50%, more preferably greater than 55%, most preferably greater than 70% of the solids-not-fat (SNF) is milk protein (by weight) and the weight ratio of casein to whey proteins is between about 95:5 and about 50:50, preferably between 90:10 and 70:30, most preferably between 90:10 and 80:20. Such concentrates are known in the art. MPCs are frequently described with the % dry matter as milk protein being appended to “MPC”. For example MPC70 is an MPC with 70% of the dry matter as milk protein. Generally MPCs are prepared by processes involving ultrafiltration either to prepare a stream enriched in casein or a stream enriched in whey protein. The streams may be blended to attain desired ratios of casein to whey protein. In another embodiment, the milk protein concentrate may be prepared by blending a stream of skim milk with a stream of WPC prepared by ultrafiltration, treating either the skim milk stream or the combined stream by cation exchange and optionally concentrating or drying.

The term “minimal crystallisation” refers to a level of crystallisation in the final product that does not result in graininess in the final product.

The term “nougat-like” texture refers to a texture of a food product being light, fluffy, airy and slightly chewy.

1.2 Calcium-Depleted Casein

It should be appreciated that the calcium-depleted casein can be any casein source in which the casein protein is depleted in calcium.

In some embodiments the calcium-depleted casein can be selected from skim milk, a milk protein concentrate, milk protein isolate, or a calcium or sodium caseinate.

Calcium-depleted milk protein concentrate (calcium-depleted MPC) for use in the invention may be prepared according to the methods of WO 01/41578 or WO 2008/026940. Calcium-depleted MPC is also known as sodium milk protein concentrate or destabilised milk protein concentrate.

The calcium-depleted MPC may be prepared by a method comprising:
(a) providing an MPC having at least 40% dry matter as milk protein in aqueous solution/suspension (on a moisture-free and fat-free weight basis);
(b) removing of calcium ions therein by a method chosen from at least one of (1) cation exchange on an ion exchanger charged substantially with a single species of monovalent cation, (2) acidification to pH 4.6-7 with subsequent dialysis and/or ultrafiltration and/or diafiltration or (3) by addition of a chelating agent and/or binding a proportion of calcium ions with a chelating or sequestering agent.

The term “calcium ions” is used broadly and includes ionic calcium, metallic calcium, protein bound calcium and colloidal calcium unless the context requires otherwise. Accordingly “calcium ions” refers to ionic calcium, particularly Ca²⁺.

The term “magnesium ions” is used broadly and includes ionic magnesium, metallic magnesium, protein bound magnesium and colloidal magnesium unless the context requires otherwise. Accordingly “magnesium ions” refers to ionic magnesium, particularly Mg²⁺.

The term “charged substantially with a single species” indicates that a resin has at least 90% of the exchangeable ions as a single species, preferably at least 95%. In particular, the term indicates that resin is not prepared by mixing of resins bearing different species or that the resin has undergone a treatment calculated to provide charging with more than one type of ion. In this aspect of the invention it is contemplated, for example, that a small proportion of the cations bound to a cation exchange resin may be resistant to exchange with the desired cation.

In another method the calcium-depleted MPC is prepared comprising:
(a) providing a low fat milk solution, for example skim milk, in liquid form;
(b) removing of calcium ions therein by a method chosen from at least of (1) cation exchange on an ion exchange in a form bearing a monovalent cation species, or (2) acidification to pH 4.6-7 optionally with subsequent dialysis; and
(c) concentrating the solution obtained by ultrafiltration, optionally with diafiltration, to form an MPC or MPI having at least 40% dry weight of protein.

Calcium-depleted MPCs are MPCs in which the calcium content is lower than the corresponding non-depleted MPC. These products generally also have a lower content of divalent cations, for example, magnesium, than corresponding non-depleted products.

The calcium-depleted MPC is preferably dried prior to mixing to form the foamable composition of the invention. Preferably, the MPC has at least 55% (on a moisture and fat-free basis), more preferably to least 70% protein and most preferably to least 80% protein. The MPC preferably has at least 30% of the calcium replaced by monovalent cations, more preferably at least 55% calcium replaced with monovalent cations, more preferably at least 70%. A preferred metal having a monovalent ion is sodium, and a preferred monovalent cation is the sodium ion. Other monovalent cations that are contemplated include potassium or ammonium.

Calcium-depleted MPC may be heat treated. WO2004/057971 describes a heat treated and decalcified milk protein concentrate (HY-MPC) that is a calcium-depleted MPC having whey proteins denatured. The denaturation is carried out by heating at a temperature above 65° C. for sufficient time to allow denaturation of whey proteins. The heating is generally carried out at a pH of 6.0-7.0, preferably 6.5-7.0. Preferably, heating is for at least 4 minutes in this embodiment.

Preferably the calcium-depleted MPC is dried to a moisture content of less than 5%, or a water activity level than facilitates storage of the dry ingredient for several months without undue deterioration.

Table 1 gives as an example the composition of calcium-depleted MPC.

TABLE 1
Composition of calcium-depleted MPC

Caclium-depleted MPC

| | Example 1 | Example 2 |
|---|---|---|
| Protein (%) | 82 | 82 |
| Casein (%) | 65.6 | 65.6 |
| Whey (%) | 16.4 | 16.4 |
| Calcium (%) | 1.3 | 0.3 |

Exemplary calcium-depleted MPC suitable for use in the present invention are commercially available from Fonterra Co-operative Limited.

1.3 Whey Protein

Whey is manufactured by coagulating milk, and is typically obtained as a by-product of cheese production. Whey is a five percent solution of lactose in water, with some minerals and lactalbumin. The concentration of protein in whey can be increased by removing lipids and other non-protein materials, for example, spray drying after membrane filtration separates the proteins from whey. Whey protein is the collection of globular proteins isolated from whey and is typically a mixture of beta-lactoglobulin (approximately 65%), alpha-lactalbumin (approximately 25%), and serum albumin (approximately 8%).

Preferably the whey protein is selected from

cheese whey,

sweet whey,

acid (lactic or mineral) whey,

whey protein concentrate (WPC),

whey protein isolate (WPI),

whey protein concentrate and whey protein isolate, and

a combination of any of the above.

More preferably the whey protein is WPC, WPI or a combination thereof.

A whey protein concentrate (WPC) is a fraction of whey from which lactose has been at least partially removed to increase the protein content to at least 20% (w/w). Preferably the WPC has at least 40%, more preferably at least 55% (w/w), even more preferably at least 65% and most preferably at least 75% of the total solids as whey protein. Preferably, the relative proportions of the various whey proteins are substantially equivalent to those of the whey from which the WPC is derived. Preferably, the WPC is an evaporated whey protein retentate. WPCs are generally prepared by ultrafiltration and/or diafiltration of whey. Preferably, the protein composition is substantially that of the whey from which it is derived.

Exemplary WPC suitable for use in the present invention are commercially available from Fonterra Co-operative Limited.

A whey protein isolate (WPI) is a WPC having at least 90% of the total solids as whey protein. Exemplary WPI suitable for use in the present invention are commercially available from Fonterra Co-operative Limited.

1.4 Foamable Composition

The foamable composition of the invention comprises calcium-depleted casein and whey protein, and the foamable composition can be whipped to produce a foam having good foaming and heat set properties.

The foamable composition of the invention can be mixed with water prior to being whipped. For example, the calcium-depleted casein, the whey protein or the mixture of calcium-depleted casein and whey protein can be mixed with water prior to whipping.

In some embodiments the foamable composition is at least partially hydrated prior to whipping.

In various embodiments the foamable composition comprises between about 1, 2, 3, 4, 5, 6, 7, 8, 9, 10, 11, 12, 13, 14, 15, 16, 17, 18, 19, 20, 21, 22, 23, 24 and about 25% w/w protein and useful ranges may be selected between any of these values (for example, about 1 to about 25, about 1 to about 21, about 1 to about 19, about 1 to about 16, about 1 to about 12, about 1 to about 8, about 1 to about 7, about 1 to about 6, about 1 to about 8, about 2 to about 25, about 2 to about 20, about 2 to about 18, about 2 to about 15, about 2 to about 11, about 2 to about 9, about 2 to about 7, about 2 to about 6, about 2 to about 5, about 4 to about 25, about 4 to about 23, about 4 to about 17, about 4 to about 14, about 4 to about 10, about 4 to about 8, about 4 to about 7, about 4 to about 6, about 5 to about 25, about 5 to about 20, about 5 to about 15, about 5 to about 10, about 5 to about 8, about 6 to about 25, about 6 to about 21, about 6 to about 14, about 6 to about 10, about 6 to about 9, about 6 to about 8, about 6 to about 7, about 7 to about 25, about 7 to about 21, about 7 to about 19, about 7 to about 16, about 7 to about 15, about 7 to about 10, about 12 to about 25, about 12 to about 22, about 12 to about 18, about 12 to about 16, about 12 to about 13, about 15 to about 16, about 15 to about 18, about 15 to about 20, about 15 to about 22, about 15 to about 25, about 17 to about 19, about 17 to about 21, about 17 to about 23, about 17 to about 25, about 20 to about 21, about 20 to about 23, about 20 to about 25, about 23 to about 25 w/w protein).

In some embodiments the ratio of calcium-depleted casein to whey protein in the foamable composition is about 3:1, 3:1.5, 3:2, 3:2.5, 5.5:4.5, 1:1, 4.5:5.5, 2.5:3, 2:3, 1.5:3 or 1:3 and useful ranges may be selected between any of these values (for example, about 3:1 to about 3:2, about 3:1 to about 3:3, about 3:1 to about 2:3, about 3:1 to about 1:3, about 3:2 to about 5.5:4.5, about 3:2 to about 1:1, about 3:2 to about 1.5:5.4, about 3:2 to about 2:3: about 5.5:4.5 to about 1:1, about 5.5:4.5 to about 4.5:5.5, about 1:1 to about 4.4:5.5, about 1:1 to about 2:3, about 4.5:5.5 to about 2:3, about 1;1 to about 1.5:3, and about 2.5:3 to about 1:3 of calcium-depleted casein to whey protein).

It should be appreciated that the foamable composition can be present in a powder form, a liquid form or in a solid form, such as a compacted powder or tablet form. Generally, the powder form is prepared with the dry mixing of the calcium-depleted casein and whey protein or with the wet mixing of one or both of the components (calcium-depleted casein and whey protein) with subsequent drying). The liquid form can be prepared from the wet mixing of one or both of the components, or from dry mixing the components with subsequent hydration. The solid form can be formed from compacting the dry powder form or by freezing the liquid form. This may be performed for transport and shipping of the foamable composition (either in its dried or liquid form, but preferably its dry form).

In some embodiments the foamable composition comprises about 25, 30, 35, 40, 45, 50, 55, 60, 65, 70 or 75% calcium-depleted casein relative to the total amount of protein provided by the calcium-depleted casein and whey protein, and useful ranges may be selected between any of these values (for example, about 25 to about 35, about 30 to about 45, about 40 to about 45, about 40 to about 50, about 40 to about 55, about 40 to about 60, about 50 to about 65, about 60 to about 75 or 70 to about 75% calcium-depleted casein per total protein).

In some embodiments the foamable composition comprises about 25, 30, 35, 40, 45, 50, 55, 60, 65, 70 or 75% whey protein relative to the total amount of protein provided by the calcium-depleted casein and whey protein, and useful ranges may be selected between any of these values (for example, about 25 to about 35, about 30 to about 45, about 40 to about 45, about 40 to about 50, about 40 to about 55, about 40 to about 60, about 50 to about 65, about 60 to about 75 or 70 to about 75% whey protein relative to the total amount of protein provided by the calcium-depleted casein and whey protein).

In some embodiments the foamable composition comprises about 25, 30, 35, 40, 45, 50, 55, 60, 65, 70 or 75% WPC relative to the total amount of protein provided by the calcium-depleted casein and whey protein, and useful ranges may be selected between any of these values (for example, about 25 to about 35, about 30 to about 45, about 40 to about 45, about 40 to about 50, about 40 to about 55, about 40 to about 60, about 50 to about 65, about 60 to about 75 or 70 to about 75% WPC relative to the total amount of protein provided by the calcium-depleted casein and whey protein).

In some embodiments the foamable composition comprises about 25, 30, 35, 40, 45, 50, 55, 60, 65, 70 or 75% WPI per total protein, and useful ranges may be selected between any of these values (for example, about 25 to about 35, about 30 to about 45, about 40 to about 45, about 40 to about 50, about 40 to about 55, about 40 to about 60, about 50 to about 65, about 60 to about 75 or 70 to about 75% WPC per total protein).

In some embodiments the foamable composition comprises about 25, 30, 35, 40, 45, 50, 55, 60, 65, 70 or 75% WPI and WPC per total protein, and useful ranges may be selected between any of these values (for example, about 25 to about 35, about 30 to about 45, about 40 to about 45, about 40 to about 50, about 40 to about 55, about 40 to about 60, about 50 to about 65, about 60 to about 75 or 70 to about 75% WPC per total protein).

In some embodiments the foamable composition includes any one or more of the following additives:

carbohydrate,

carbohydrate syrup,

sugar,

sugar syrup,

whey protein,

flavour,

thickener,

salt,

acid,

alkali,

stabiliser, and

gum.

As an additional additive, the foamable composition may include an acid selected from tartaric acid, citric acid, acetic acid, fumaric acid, lactic acid, or potassium acid tartarate or a mixture thereof.

As an additional additive, the foamable composition may include an alkali selected from ammonium bicarbonate, potassium carbonate, sodium carbonate, sodium citrate, or trisodium citrate or a mixture thereof.

As an additional additive, the foamable composition may include a salt selected from sodium chloride, potassium citrate, calcium citrate, ammonium phosphate, calcium gluconate, potassium acid tartarate, or potassium phosphate or a mixture thereof.

As an additional additive, the foamable composition may include a gum selected from locust bean gum, guar gum, xanthan gum, cassia gum, konjac flour, beta-glucan, tara gum, gum arabic, gellan gum, carboxymethylcellulose, methylcellulose, hydroxypropyl methylcellulose, tragacanth gum, karaya gum, gum acacia, chitosan, arabinoglactins, agar, gelatine, pectin, methyl cellulose, carboxymethyl cellulose, alginate, pectin, carrageenan, or psyllium or a mixture thereof.

In some embodiments additional whey is added to the foamed protein concentrate. Preferably the additional whey is WPC, WPI or a mixture of WPC and WPI.

In some embodiments the foamable composition comprises about 1, 5, 10, 15, 20, 25, 30, 35, 40, 45, 50, 55, 60, 65, 70 or 75% w/w additional whey protein, and useful ranges may be selected between any of these values (for example, about 1 to about 75, about 1 to about 50, about 1 to about 30, about 10 to about 70, about 10 to about 55, about 10 to about 40, about 15 to about 60, about 15 to about 50, about 15 to about 40, about 15 to about 35, about 20 to about 75, about 20 to about 50, about 20 to about 40, about 20 to about 35, 25 to about 35, about 30 to about 45, about 40 to about 45, about 40 to about 50, about 40 to about 55, about 40 to about 60, about 50 to about 65, about 60 to about 75 or 70 to about 75% w/w additional whey protein).

1.5 Method of Forming a Foam

Another aspect of the invention relates to a method of making a foam comprising the steps of

(1) providing calcium-depleted casein and whey protein,

(2) mixing the calcium-depleted casein and whey protein, and

(3) whipping the mixture

wherein a source of water is added to the calcium-depleted casein or the whey protein or is added to the mixture prior to, or during, being whipped.

Another aspect of the invention relates to a method of making a foam comprising the steps of
(1) providing about 1 to 25% w/w protein by mixing calcium-depleted casein, whey protein and a source of water,
(2) at least partially hydrating the calcium-depleted casein or the whey protein or the mixture of the calcium-depleted casein and whey protein, and
(3) whipping the mixture.

Another aspect of the invention relates to a method of making a foam comprising the steps of
(1) providing about 1 to 25% w/w protein by mixing calcium-depleted casein, whey protein and a source of water, and
(2) whipping the mixture.

Another aspect of the invention relates to a method of making a foam comprising the steps of
(1) preparing a protein concentrate from calcium-depleted casein and whey protein,
(2) mixing the protein concentrate with a source of water so that the protein concentration in the protein concentrate is about 1 to about 25% w/w, and
(3) whipping the protein concentrate to a foam.

Another aspect of the invention relates to a method of making a foam comprising the steps of
(1) providing a protein source where the protein source is selected from calcium-depleted casein and whey protein,
(2) mixing the protein sources, and
(3) whipping the mixture

wherein the protein source mix is in a at least partially hydrated state prior to, or during, being whipped.

Another aspect of the invention relates to a method of making a foam comprising the steps of

(1) providing calcium-depleted casein and whey protein,

(2) mixing the calcium-depleted casein and whey protein with a source of water, and

(3) whipping the mixture.

In some embodiments, the method comprises an initial step of mixing calcium-depleted casein and the whey protein to form the protein concentrate at 1-25% relative to the total amount of protein provided by the calcium-depleted casein and whey protein.

In another embodiment the method comprises, prior to the whipping step, a step of hydrating the protein concentrate, the calcium-depleted casein or the whey protein.

In another embodiment, the method comprises, prior to the mixing step, a step of hydrating the calcium-depleted casein or the whey protein.

In some embodiments the calcium-depleted casein and whey protein are dry blended prior to the addition of water and whipping.

In some embodiments the protein concentrate is at least partially hydrated prior to the protein concentrate being whipped.

In some embodiments the protein concentrate is fully hydrated prior to the protein concentrate being whipped.

In some embodiments the calcium-depleted casein is mixed with water prior to mixing with dry whey protein. Preferably the hydrated calcium-depleted casein and dry whey protein mix is further mixed with water prior to whipping, preferably to at least 25% w/w protein.

In some embodiments the whey protein is mixed with water prior to mixing with the dry calcium-depleted casein. Preferably the whey protein and dry calcium-depleted casein is further mixed with water prior to whipping, preferably to at least 25% w/w protein.

In some embodiments the calcium-depleted casein and whey protein are wet blended prior to whipping, or prior to further hydration and whipping.

In some embodiment, when the mixture is partially hydrated, for example when the mix is formed from a wet/dry mix of hydrated calcium-depleted casein, or of hydrated whey protein, or both hydrated calcium-depleted casein and whey protein, the hydrated or partially hydrated mixture is dried prior to the hydration step and subsequent whipping.

In some embodiments the protein concentrate is hydrated for about 15, 20, 25, 30, 35, 40, 45, 50, 55, or 60 min, and useful ranges may be selected between any of these values (for example, about 15 to about 25, about 15 to about 30, about 15 to about 45, about 15 to about 60, about 20 to about 30, about 20 to about 40, about 20 to about 50, about 20 to about 60, about 35 to about 45, about 35 to about 60, about 40 to about 45, about 40 to about 50, about 50 to about 55 and about 55 to about 60 min).

In some embodiments the protein concentrate is hydrated at about 20, 25, 30, 35, 40, 45, 50, 55 or 60° C., and useful ranges may be selected between any of these values (for example, about 20 to about 30, about 20 to about 40, about 20 to about 50, about 20 to about 60, about 25 to about 35, about 25 to about 45, about 25 to about 55, about 30 to about 45, about 30 to about 55, about 30 to about 60, about 45 to about 50, about 45 to about 60, about 50 to about 55, about 50 to about 60 and about 55 to about 60° C.).

In some embodiments the protein concentrate is whipped with high shear force for 3, 4, 5, 6 7, 8, 9, or 10 min, and useful ranges may be selected between any of these values (for example, about 3 to about 4, about 3 to about 5, about 3 to about 6, about 3 to about 8, about 3 to about 10, about 4 to about 5, about 4 to about 7, about 4 to about 8, about 4 to about 10, about 5 to about 7, about 5 to about 9, about 6 to about 8, about 6 to about 10, about 7 to about 9 and about 8 to about 10 min).

In some embodiments the protein concentrate is whipped using high shear force. It should be appreciated that any equipment could be used to mix the hydrated protein concentrate, provided it can produce high shear that will create a foam. Typically, the protein concentrate may be whipped in the same manner under the same conditions with the same equipment as egg white.

In some embodiments a Hobart or Bear mixer is used. The settings used on either mixer will depend on the instrument used. For example, with the Hobart mixer speed 3 is equivalent to 350 revs per minute and is used to whip the protein concentrate. With the Bear Varimixer 150 revs per minute is used to whip the concentrate.

In some embodiments the highest frequency is used for whipping but it should be appreciated that the whip time could change from about 3 to about 5 minutes depending on the machine used.

Once whipped the protein concentrate forms a foam having high overrun. Overrun is calculated as: ((weight of 100 ml of original protein solution−weight of 100 ml of foam)/weight of 100 ml of foam)*100.

In some embodiments the overrun is 200, 300, 400, 500, 600, 700, 800, 900, 1000, 1100, 1200, 1300, 1400 or 1500%, and useful ranges may be selected between any of these values (for example, about 200 to about 400, about 200 to about 600, about 200 to about 800, about 200 to about 1000, about 200 to about 1200, about 200 to about 1400, about 300 to about 500, about 300 to about 800, about 300 to about 1200, about 300 to about 1500, about 400 to about 900, about 500 to about 700, about 500 to about 1300, about 500 to about 1500, about 700 to about 1100, about 900 to about 1200, about 900 to about 1500, about 1100 to about 1300, and about 1100 to about 1500% overrun).

In some embodiments the foam expansion is up to 10, 20, 30, 40 or 50%, and useful ranges may be selected between any of these values (for example, about 10 to about 20, about 10 to about 30, about 10 to about 50, about 20 to about 30, about 20 to about 40, about 30 to about 40, about 30 to about 50, about 40 to about 50% foam expansion).

In some embodiments the whipped protein concentrate has high viscosity. Preferably the viscosity of the whipped protein is about 280,000, 300,000, 320,000, 340,000, 360,000, 380,000, 400,000, 420,000 or 450,000 cP and useful ranges may be selected between any of these values (for example about 280,000 to about 450,000, about 280,000 to about 400,000, about 280,000 to about 360,000, about 280,000 to about 300,000, about 320,000 to about 450,000, about 320,000 to about 420,000, about 320,000 to about 380,000, about 320,000 to about 340,000, about 360,000 to about 450,000, about 360,000 to about 400,000, about 380,000 to about 450,000, about 380,000 to about 420,000 or about 400,000 to about 450,000 cP).

More preferably the viscosity of the whipped protein is between about 320,000 to about 400,000 cP.

In some embodiments the whipped foamable composition has high stability.

Those skilled in the art will recognise that preferred concentrates of the invention have foaming and heat set characteristics similar to, equivalent to, or better than that of egg white, and the latter provides a suitable reference against which such characteristics may be assessed. In some embodiments, preferred protein concentrates of the invention, when whipped under the same conditions as an equivalent amount of egg white, will form a foam having at least about 70%, preferably 80%, and more preferably at least 90% the stability of egg white foam. In some embodiments, preferred protein concentrates of the invention, when whipped under the same conditions as an equivalent amount of egg white, will form a foam having at least about 70%, preferably 80%, and more preferably at least 90% the viscosity of egg white foam. In some embodiments, preferred protein concentrates of the invention, when whipped under the same conditions as an equivalent amount of egg white, will form a foam having at least about 70%, preferably 80%, and more preferably at least 90% the foam volume of egg white foam.

1.6 Products

Another aspect of the invention relates to the use of a foamable composition comprising calcium-depleted casein and whey protein.

Another aspect of the invention relates to a kit comprising calcium-depleted casein and whey protein, wherein the kit provides instructions to mix the calcium-depleted casein and whey protein and whip to a foam. Preferably the kit also includes instruction to mix the calcium-depleted casein, whey protein, or calcium-depleted casein and whey protein with a source of water prior to whipping.

Another aspect of the invention relates to a kit comprising calcium-depleted casein and whey protein, wherein the kit provides instructions to mix the calcium-depleted casein and whey protein to form a protein concentrate, mix the protein concentrate with water, and then whip the mixture to a foam.

It should be appreciated that the foamable composition or protein concentrate can be used in food products as a substitute or replacer of egg white. In some embodiments the food product is a confectionary or a baked good. Preferably the protein concentrate is used in confectionary such as bars, baking, juices and dessert foods such as nougat, marshmallow, meringue, sponge cakes and dairy based desserts.

In some embodiments the foamable composition or protein concentrate is used in the preparation of a product, where manufacture of the product includes the step of adding a sugar syrup to the protein concentrate. Such products include a nougat.

In traditional nougat manufacture sucrose is the main ingredient used. Sucrose, along with glucose syrup, is dissolved and boiled to temperatures >118° C. to achieve the desired nougat-like texture. A nougat-like texture is defined as being light, fluffy, airy and slightly chewy.

High levels of sucrose causes graininess in the final product: the graininess resulting from crystallisation.

In some embodiments there is provided a method of making a food product comprising the steps of
(1) providing a protein concentrate that comprises calcium-depleted casein and whey protein,
(2) mixing a heated sugar syrup substantially free of sucrose with the protein concentrate, and

wherein the food product has a light and fluffy texture with minimal crystallisation.

In some embodiments there is provided a method of making a food product comprising the steps of
(1) providing a hydrated whipped protein concentrate that comprises calcium-depleted caseinate and whey protein,
(2) mixing a heated sugar syrup substantially free of sucrose with the hydrated whipped protein concentrate, and

wherein the food product has a light and fluffy texture with minimal crystallisation.

In some embodiments the sugar syrup is water.

Preferably the sugar syrup comprises glucose. It should be appreciated that any other non-sucrose containing syrup could also be used provided it does not result in an amount of crystallisation that leads to graininess in the final product. Examples of such syrups include high fructose corn syrup, brown rice syrup, polyol syrups, soluble fiber syrups, polydextrose syrup, rice syrup, and corn syrup.

In some embodiments the ratio of glucose to glycerine is about 1:1, 2:1, 3:1, 4:1, 5:1, 6:1, 7:1, or 8:1 glucose to glycerine and useful ranges may be selected between any of these values (for example, about 1:1 to about 8:1, about 1:1 to about 6:1, about 1:1 to about 4:1, about 2:1 to about 8:1, about 2:1 to about 6:1, about 3:1 to about 6:1 3:1 to about 7:1, about 3:1 to about 8:1, about 4:1 to about 6:1, about 4:1 to about 7:1, about 4:1 to about 8:1 to about 6: to about 8:1 glucose to about glycerine).

In some embodiments the syrup is heated to a temperature of 60, 65, 70, 75, 80, 85, 90, 95 or 100° C. and useful ranges may be selected between any of these values (for example, about 60 to about 100, about 60 to about 95, about 70 to about 100, about 70 to about 95, about 75 to about 100, about 75 to about 95, about 80 to about 100, about 80 to about 95, about 60 to about 80, about 70 to about 90, about 65 to about 85, and about 75 to about 85° C.).

### EXAMPLES

### Example 1

### Comparison to Egg White

The characteristics of seven protein products were benchmarked against egg white. The results are shown in Table 2.

TABLE 2
Results of egg white benchmark tests on seven products.

| | Whippability | Stability | Viscosity (cP) |
|---|---|---|---|
| | Foam Volume | Drip @ 1 | 20 rpm |
| | (ml) | hr (ml) | 25 sec |
| Egg white | 2500 | 0 | 44,375 |
| MPC (81% protein; 90% calcium depletion) | 2400 | 4 | 17,702 |
| WPI (94% protein) | 1500 | 33 | 5,581 |
| WPI (91% protein) | 1400 | 24.1 | 6,914 |
| MPC (81% protein; 45% calcium depletion) | 1290 | 17 | 11,319 |
| MPC (81% protein; 65% calcium depletion) | 1500 | 9.6 | 12,553 |
| WPC (80% protein) | 1000 | 56.2 | 4,787 |

While MPC (81% protein; 90% calcium depletion) performed best in whippability and viscosity tests, it performed less well in the foam stability tests.

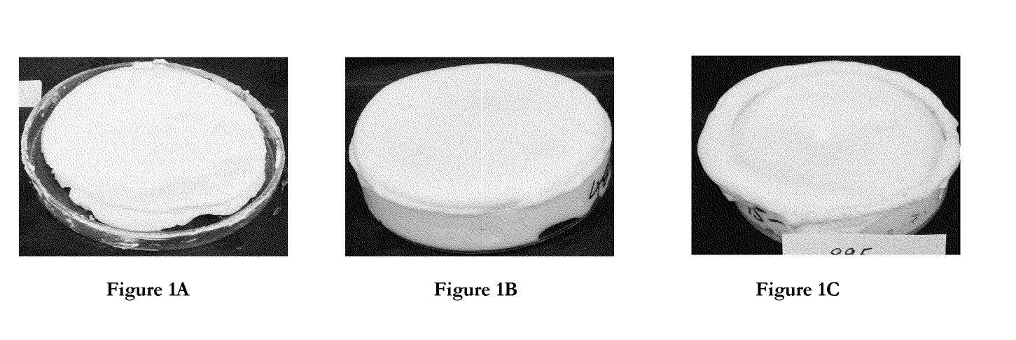

Shown in FIGS. 1A-1C are the results of a heat set test using egg white (FIG. 1A), MPC (81% protein; 90% calcium depletion) (FIG. 1B) and WPI (94% protein) (FIG. 1C). The heat set test was performed by adding hot sugar syrup with 10% protein. As can be seen in FIGS. 1B and 1C, neither MPC (81% protein; 90% calcium depletion) nor WPI (94% protein) performed as well as egg white.

Therefore, none of the MPCs or WPCs alone performed well in the viscosity test nor did any of the MPCs or WPCs have good heat set properties.

MPC (81% protein; 90% calcium depletion) was optimised to improve viscosity and heat set properties by varying:

protein concentration from 5 to 20%,

protein hydration temperature from 10 to 60° C., and

protein hydration time from 20 to 180 minutes.

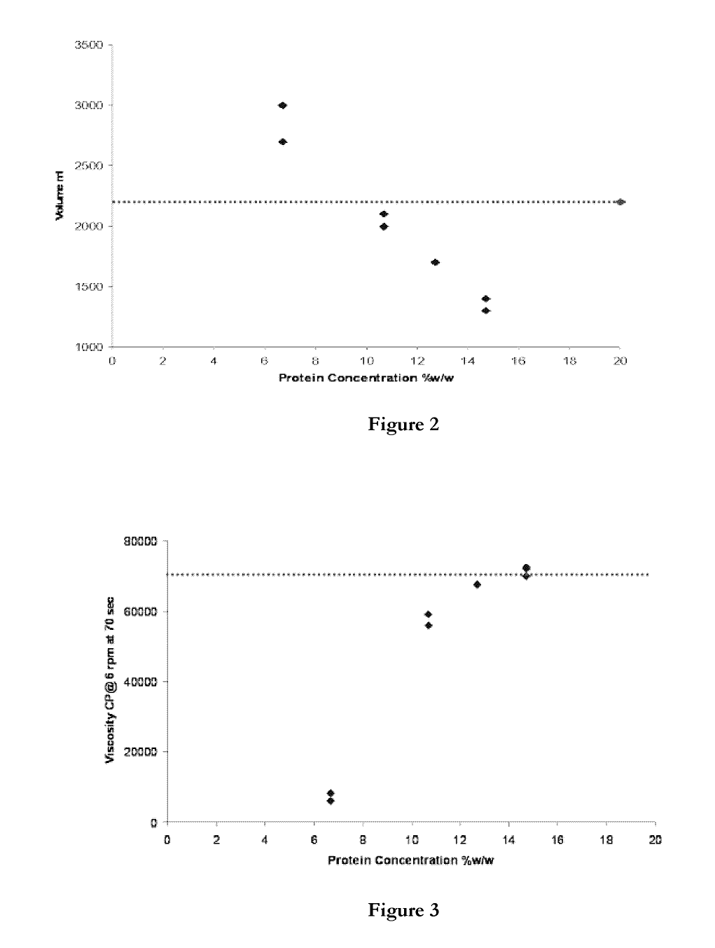

The results of the optimisation tests are shown in FIGS. 2 and 3. FIG. 2 shows that foam volume decreases with increasing protein concentration with 11% protein showing the closest result to the egg white benchmark. FIG. 3 shows that foam viscosity increases with increasing protein concentration with 15% protein showing the closest result to the egg white benchmark.

From this study, the optimum conditions to get improved foam viscosity were:

approximately 11% protein concentration,

45° C. protein hydration temperature, and

60 min protein hydration time.

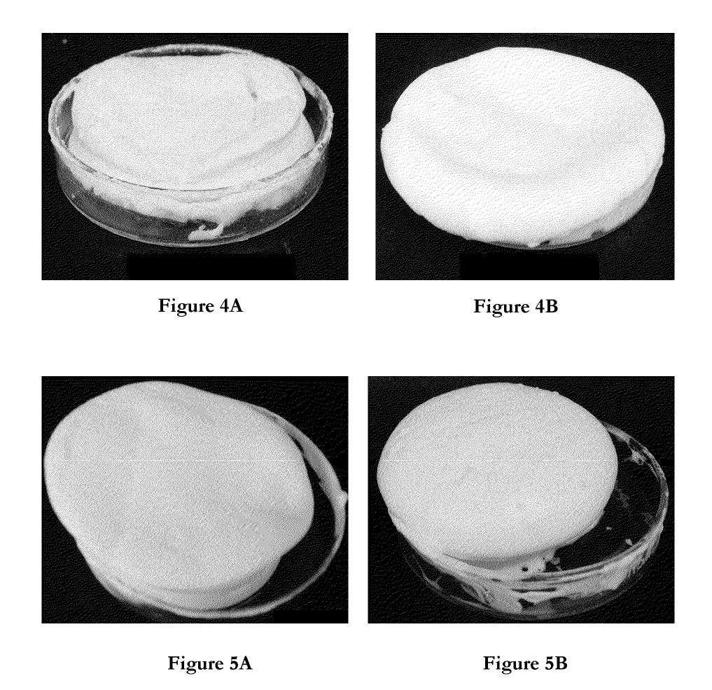

As shown in FIG. 4A and FIG. 4B, the heat set performance of 10.5% MPC (81% protein; 90% calcium depletion) (FIG. 4B) was evaluated by comparing to 20% protein egg white solution (FIG. 4A). The heat set properties of MPC (81% protein; 90% calcium depletion) were not similar to the benchmark egg white. Egg white foam coagulated and was drier than the MPC (81% protein; 90% calcium depletion) foam.

### Example 2

### Blend of Calcium-Depleted MPC and WPC

The foaming and heat set characteristics of a milk protein blend was investigated. Whipping tests were performed on a blend of calcium-depleted MPC and WPC. Protein concentrations tested were at 20% w/w protein concentration.

TABLE 3
Whipping tests comparing a calcium-depleted MPC/WPC blend
and egg white.

| | Whippability | |
|---|---|---|
| | Foam | Viscosity |
| | volume (ml) | (cP) |
| Egg white | 2400 | 396,111 |
| Protein concentrate | 2210 | 351,111 |

As shown in Table 3 above, the foam volume and foam viscosity characteristics of the MPC/WPC blend were comparable to those of egg white.

The heat set characteristics of the foams were then assessed. As shown in FIG. 5A and FIG. 5B, the heat set performance of a 20% calcium-depleted MPC/WPC blend (FIG. 5B) was evaluated by comparing to 20% protein egg white solution (FIG. 5A). The heat set performance of the calcium-depleted MPC/WPC blend showed excellent heat set performance with sugar syrup, again comparable to that of egg white.

Therefore, the blend of calcium-depleted MPC and WPC produces a foam that is very similar to the egg white bench mark.

### Example 3

### Preparation of Short Grained Nougat

The following example illustrates the use of the protein concentrate of the present invention to produce nougat.

As a first step, the dried protein concentrate comprising calcium-depleted MPC and WPC is prepared. The protein concentrate is formed as a blend comprising 50% MPC (81% protein; 90% calcium depletion) (81.4 protein), 30% WPC (80% protein) (80.3 whey protein) and 20% WPI (94% protein) (93.5% whey protein). This dried protein concentrate is hydrated in water for 1 hour at 45° C. It should be appreciated that instead of beginning with dried protein concentrate, the hydrated protein concentrate could have been prepared by mixing dried/wet calcium-depleted MPC and WPC (for example, wet calcium-depleted MPC and dry WPC or dry calcium-depleted MPC and wet WPC or wet calcium-depleted MPC and wet WPC).

Table 4 shows an example of the preparation of a hydrated protein concentrate.

TABLE 4
Preparation of hydrated protein concentrate
formed from a blend of calcium-delpleted MPC and WPC.

| Hydrated protein concentrate | % | Weight (g) |
|---|---|---|
| Dry protein concentrate | 12 | 48 |
| Water | 38 | 152 |
| Total | 50 | 200 |

In the next step, a sugar mixture, as exemplified in Table 5, is prepared.

TABLE 5
Sugar mixture

| Sugar Syrup | % | Weight (g) |
|---|---|---|
| Glucose Syrup | 31 | 775 |
| Sucrose | 48 | 1200 |
| Water | 16 | 400 |
| Malt extract | 3 | 45 |
| Total | 98 | 2450 |

The sugar mixture is heated to 130° C. When the temperature of the sugar mixture reaches about 120° C. approximately 200 g of boiled sugar is removed. This portion is used for the protein concentrate. To the sugar mixture, malt extract is added and boiling is continued without stirring. The cooked mixture is then removed from the heat.

The protein concentrate is placed into a Bear mixer and whisked at the highest speed for approximately five minutes. The approximately 200 g (one fifth) of sugar syrup is added to the protein concentrate over about one minute while the Bear mixer is reduced to its lowest speed. Once all of the 200 g (one fifth) of sugar mixture has been added to the protein concentrate, the Bear mixer is turned to its highest speed for approximately another three minutes until smooth stiff peaks are formed in the foam.

The remaining sugar syrup is mixed into the foamed protein concentrate, while the Bear mixer is at its lowest speed and the mixing is continued for approximately one minute, to form a frappe.

Cocoa, WPC and maltodextrin is premixed and added to the frappe and folded in manually.

A fat/glycerine mixture is prepared by mixing well palm kernel oil, lecithin and glycerine at low heat (approximately 50° C.). This mixture is mixed into the frappe until well blended.

The mixture is then poured onto a tray or pottles and is allowed to set at room temperature to form the nougat.

The above results show that the calcium-depleted MPC/WPC blend, comprising protein concentrates of the present inventions, can be used as a foaming ingredients in the preparation of foods. e.g. as a substitute for egg white.

### Example 4

### Preparation of High Protein Aerated ‘Nougat’-Like Bar

The following example illustrates the use of the protein concentrate of the present invention to produce an aerated nougat-like bar.

As a first step, the dried protein concentrate comprising calcium-depleted MPC and whey protein is prepared. The protein concentrate is formed as a blend comprising 50% MPC (81% protein; 90% calcium depletion) (81.4 protein), 30% WPC (80% protein) (80.3 whey protein) and 20% WPI (94% protein) (93.5% whey protein). This dried protein concentrate is hydrated in water/Glucose syrup (DE60) at 60° C. for 30 minutes. It should be appreciated that instead of beginning with dried protein concentrate, the hydrated protein concentrate could have been prepared by mixing dried/wet calcium-depleted MPC and whey protein (for example, wet calcium-depleted MPC and dry whey protein [i.e. whether WPC, WPI or WPC and WPI] or dry calcium-depleted MPC and wet whey protein or wet calcium-depleted MPC and wet whey protein).

TABLE 6
Preparation of a hydrated protein concentrate.

| Ingredient | % w/w |
|---|---|
| Dry protein concentrate | 4.2 |
| Glucose syrup, DE 60 | 6.7 |
| Water | 6.7 |
| Glucose syrup, DE 40 | 39.2 |
| Glycerine | 10.8 |
| Protein powder | 27.7 |
| Maltodextrin | 1.7 |
| Palm kernel oil | 3.0 |
| Lecithin | 0.05 |
| Total | 100 |

The glucose syrup (DE 40), and Glycerine are weighed and heated up to about 95° C.

The hydrated protein solution is then transferred to a Bear mixer and is whisked at maximum for approximately 5 minutes.

Approximately 450 g of the sugar/glycerine syrup is added to the hydrated and whisked protein solution over about 1 minute at the lowest whisk speed and beating is continued at the highest speed for another 3 minutes until smooth stiff peaks are formed.

The remaining glucose/glycerine syrup is reheated to about 95° C. and, if necessary, whisked into the protein whip at the lowest speed. The mixing is continued at speed 1 for another minute.

The palm kernel oil and lecithin are melted over a stove a low heat (˜50° C.) and mixed well.

The pre-mixed protein powder and maltodextrin is gradually added to the frappe and is fold in manually. The fat/glycerine mixture is then added into the frappe and mixed until well blended.

The mixture is then poured on to a tray lined with baking paper and let it set at room temperature to form the nougat.

### Example 5

### Low-Fat Chocolate Mousse

The following example illustrates the use of the protein concentrate of the present invention to produce a low-fat chocolate mousse.

As a first step, the dried protein concentrate comprising calcium-depleted MPC and WPC is prepared. The protein concentrate is formed as a blend comprising 50% MPC (81% protein; 90% calcium depletion) (81.4 protein), 30% WPC (80% protein) (80.3 whey protein) and 20% WPI (94% protein) (93.5% whey protein). This dried protein concentrate is hydrated in water for 30 min at 60° C. It should be appreciated that instead of beginning with dried protein concentrate, the hydrated protein concentrate could have been prepared by mixing dried/wet calcium-depleted MPC and WPC (for example, wet calcium-depleted MPC and dry WPC or dry calcium-depleted MPC and wet WPC or wet calcium-depleted MPC and wet WPC).

Table 7 shows an example of the preparation of a hydrated protein concentrate, and Table 8 shows the ingredients used to make a low-fat chocolate mousse.

TABLE 7
Preparation of a hydrated protein concentrate
formed from a blend of calcium-depleted MPC and WPC.

| Hydration of the protein concentrate | | |
|---|---|---|
| Water | 41.42 | 186.38 |
| Dry protein concentrate | 14.08 | 58.40 |
| Total | 54.40 | 244.80 |

TABLE 8
Ingredients for preparing a low-fat chocolate mousse.

| Ingredients | % w/w | Batch (g) |
|---|---|---|
| Hydrated protein concentrate | 54.40 | 244.80 |
| Compound milk chocolate | 32.90 | 148.05 |
| Water | 8.00 | 36.00 |
| Sucrose | 3.00 | 13.50 |
| Gelatine | 1.40 | 6.30 |
| Lecithin | 0.30 | 1.35 |
| Total | 100.00 | 450.00 |

The process for manufacturing the low-fat chocolate mousse is as follows.
Chocolate and lecithin are placed in a bowl over simmering water to melt. It will be appreciated that to avoid grainy chocolate at 55° C. the bowl of water should not touch the water nor should the water be allowed to boil. The chocolate is kept warm until the foam is prepared.
Gelatine is hydrated in water and melted in a pot of simmering water.
The hydrated protein concentrate is added to the gelatine and the mixture is whisked for 1 minute at high speed using a Hobart mixer.
Following mixing, sucrose and a half teaspoon of vanilla is gradually into the mixture.
The mixture is whipped for another 3 minutes at high speed.
The chocolate mixture is whisked into the whip for 10-15 seconds or until the mixture is homogenous.
The resultant mixture can then be poured into cups and refrigerated prior to consumption.

In this example all of the egg white has been replace with a 20% protein solution of the hydrated protein concentrate. The final product was light and stable with a clean flavour.

### Example 6

### Indulgent Chocolate Mousse

The following example illustrates the use of the protein concentrate of the present invention to produce an indulgent chocolate mousse.

As a first step, the dried protein concentrate comprising calcium-depleted MPC and WPC is prepared. The protein concentrate is formed as a blend comprising 50% MPC (81% protein; 90% calcium depletion) (81.4 protein), 30% WPC (80% protein) (80.3 whey protein) and 20% WPI (94% protein) (93.5% whey protein). This dried protein concentrate is hydrated in water for 30 min at 60° C. It should be appreciated that instead of beginning with dried protein concentrate, the hydrated protein concentrate could have been prepared by mixing dried/wet calcium-depleted MPC and WPC (for example, wet calcium-depleted MPC and dry WPC or dry calcium-depleted MPC and wet WPC or wet calcium-depleted MPC and wet WPC).

Table 9 shows an example of the preparation of a hydrated protein concentrate, and Table 10 shows the ingredients used to make a indulgent chocolate mousse.

TABLE 9
Preparation of a hydrated protein concentrate
formed from a blend of calcium-depleted MPC and WPC.

| | | Weight |
|---|---|---|
| Hydration of protein concentrate | % | (g) |
| Water | 24.36 | 109.64 |
| Dry protein concentrate | 7.64 | 34.36 |
| Total | 32.00 | 144.00 |

TABLE 10
Ingredients for preparing an indulgent chocolate mousse.

| Ingredients | % w/w | Batch (g) |
|---|---|---|
| Hydrated protein concentrate | 32.00 | 144.00 |
| Compound milk chocolate | 28.00 | 126.00 |
| Liquid cream | 15.70 | 70.65 |
| Sucrose | 7.00 | 31.50 |
| Water | 6.00 | 27.00 |
| Whey Protein Concentrate 515 | 5.00 | 22.50 |
| Salted butter | 5.00 | 22.50 |
| Gelatine | 1.00 | 4.50 |
| Lecithin | 0.30 | 1.35 |
| Total | 100.00 | 450.00 |

The process for manufacturing the indulgent chocolate mousse is as follows.
Chocolate and lecithin are placed in a bowl over simmering water to melt. It will be appreciated that to avoid grainy chocolate at 55° C. the bowl of water should not touch the water nor should the water be allowed to boil. The chocolate is kept warm until the foam is prepared.
Gelatine is hydrated in water and melted in a pot of simmering water.
The hydrated protein concentrate is added to the gelatine and the mixture is whisked for 1 minute at high speed using a Hobart mixer.
Following mixing sucrose is gradually into the mixture and the mixture is whipped for another minute at high speed.
WPC (80% protein) is added into the mixture while mixing at low speed.
The mixture is whipped for another two minutes at high speed (i.e. four minutes whipping time in total).
In another Hobart bowl, fresh cream and half a teaspoon of vanilla is whipped for approximately one minute until soft peaks form.
The chocolate mixture is whisked into the whip for 3-4 seconds or until the mixture is homogenous.
Whipped cream is folded in.
The resultant mixture can then be poured into cups and refrigerated prior to consumption.

This example gave a light and creamy mousse.

### Example 7

### Marshmallow

The following example illustrates the use of the protein concentrate of the present invention to produce marshmallow.

As a first step, the dried protein concentrate comprising calcium-depleted MPC and WPC is prepared. The protein concentrate is formed as a blend comprising 50% MPC (81% protein; 90% calcium depletion) (81.4 protein), 30% WPC (80% protein) (80.3 whey protein) and 20% WPI (94% protein) (93.5% whey protein). This dried protein concentrate is hydrated in water for 30 min at 60° C. It should be appreciated that instead of beginning with dried protein concentrate, the hydrated protein concentrate could have been prepared by mixing dried/wet calcium-depleted MPC and WPC (for example, wet calcium-depleted MPC and dry WPC or dry calcium-depleted MPC and wet WPC or wet calcium-depleted MPC and wet WPC).

Table 11 shows the ingredients used to make marshmallow.

TABLE 11
Ingredients for preparing marshmallow.

| Ingredients | % w/w | Batch (g) |
|---|---|---|
| Sucrose | 50.43 | 252.14 |
| Glucose syrup (DE 60) | 23.60 | 117.98 |
| 1st portion of water (for sugar boiling) | 8.10 | 40.50 |
| 2nd portion of water (for protein concentrate hydra- | 7.33 | 36.63 |
| tion) | | |
| 3rd portion of water (for gelatine hydration) | 5.60 | 28 |
| Gelatine | 2.66 | 13.32 |
| Dry protein concentrate | 2.28 | 11.42 |
| Total | 100.00 | 500.00 |

The process for manufacturing the marshmallow is as follows.
The gelatine is hydrated with the third portion of water. The solution is stirred gently until it is fully dissolved.
The gelatine is added into the protein solution and mixed well.
The mixture is whisked for five minutes until a stiff peak forms.
The syrup is prepared by measuring the second addition of water, granulated sugar, and glucose syrup into a pan and heating to 112° C.
One fifth of the sugar is added into the foam and whisked for another three minutes.
The remainder of the syrup is added to the foam.
The mixture is whisked for two minutes on high speed.
The mixture is cast or deposited into a mixture of corn starch and icing sugar and held overnight to set.

This process produces a very light and fluffy marshmallow product.

### Example 8

### Marshmallow Cream

The following example illustrates the use of the protein concentrate of the present invention to produce marshmallow cream.

As a first step, the dried protein concentrate comprising calcium-depleted MPC and WPC is prepared. The protein concentrate is formed as a blend comprising 50% MPC (81% protein; 90% calcium depletion) (81.4 protein), 30% WPC (80% protein) (80.3 whey protein) and 20% WPI (94% protein) (93.5% whey protein). This dried protein concentrate is hydrated in water for 30 min at 60° C. It should be appreciated that instead of beginning with dried protein concentrate, the hydrated protein concentrate could have been prepared by mixing dried/wet calcium-depleted MPC and WPC (for example, wet calcium-depleted MPC and dry WPC or dry calcium-depleted MPC and wet WPC or wet calcium-depleted MPC and wet WPC).

Table 12 shows the ingredients used to make marshmallow cream.

TABLE 12
Ingredients for preparing marshmallow cream.

| Ingredients | % w/w | Batch (g) |
|---|---|---|
| Sucrose | 54.40 | 272.00 |
| Glucose syrup (DE 60) | 24.80 | 124.00 |
| 1st portion of water (for sugar boiling) | 9.30 | 46.50 |
| 2nd portion of water (for whipping protein hydra- | 7.70 | 38.50 |
| tion) | | |
| Dry protein concentrate | 2.40 | 12.00 |
| Gelatine | 1.40 | 7.00 |
| Total | 100.00 | 500.00 |

The process for manufacturing the marshmallow cream is as follows.
The gelatine is added to the hydrated protein concentrate solution after 20 minutes of hydration. The solution is hydrated for a further 10 minutes.
The solution is whisked for five minutes until it forms a stiff peak.
A syrup is prepared by combining water, granulated sugar, and glucose syrup into a pan and heated to 112° C.
One fifth of the sugar is added into the foam and whisked for another three minutes.
The remainder of the syrup is added to the foam.
The mixture is whisked for two minutes on high speed.
The mixture is left to set overnight over a layer of a mixture of corn starch and icing sugar.

This example is suitable as a spread or layer on desserts, confectionery and snacks.

### Example 9

### High Protein Marshmallow

The following example illustrates the use of the protein concentrate of the present invention to produce a high protein marshmallow. The protein concentrate is formed as a blend comprising 50% MPC (81% protein; 90% calcium depletion) (81.4 protein), 30% WPC (80% protein) (80.3 whey protein) and 20% WPI (94% protein) (93.5% whey protein).

Table 13 shows an example of the preparation of a hydrated protein concentrate, and Table 14 shows the ingredients used to make a high protein marshmallow.

TABLE 13
Preparation of hydrated protein concentrate
formed from a blend of calcium-depleted MPC and WPC

| Hydration of protein concentrate | % | Weight (g) |
|---|---|---|
| Water | 21.12 | 105.62 |
| Glycerine | 10.19 | 50.,95 |
| Dry protein concentrate | 8.60 | 43.43 |
| Total | 40.00 | 200.00 |

TABLE 14
Ingredients for preparing high protein marshmallow.

| Ingredients | % w/w | Batch (g) |
|---|---|---|
| Hydrated protein concentrate | 40.00 | 200.00 |
| Sucrose | 26.00 | 130.00 |
| Whey Protein Concentrate 515 | 23.00 | 115.00 |
| Water | 6.00 | 30.00 |
| Glucose syrup (DE 40) | 3.00 | 15.00 |
| Gelatine | 2.00 | 10.00 |
| Total | 100.00 | 500.00 |

The process for manufacturing the high protein marshmallow is as follows.
The sugar, water (first water) and glucose syrup (DE40) is weighed into a pot and heated, while stirring, to approximately 120° C.
The gelatine, protein concentrate and glycerine is weighed into a beaker. The mixture is hydrated 60° C. with a mixing head stirrer for 30 minutes.
WPC (80% protein) is weighed into a Hobart Mixer bowl.
The protein concentrate mixture is added to the protein powder in the mixing bowl and mixed on medium (setting 2) until well combined.
The mixer is then set to 3 and beat until a stiff peak forms.
The mixer is then set to slow (setting 2), and hot sugar syrup added in as a constant stream.
Once all the ingredients are mixed the mixer is set to high (to setting 3) and mixed until stiff and fluffy.
The marshmallow like product is mixed onto a lined tray that has been well covered with corn flour. The product can be cut into bars and enrobed with chocolate or other compound.

This example is suitable for a light and fluffy layer in nutrition bars.

### Example 10

### Meringue

The following example illustrates the use of the protein concentrate of the present invention to produce a meringue. The protein concentrate is formed as a blend comprising 50% MPC (81% protein; 90% calcium depletion) (81.4 protein), 30% WPC (80% protein) (80.3 whey protein) and 20% WPI (94% protein) (93.5% whey protein).

As a first step, the dried protein concentrate comprising calcium-depleted MPC and WPC is prepared. This dried protein concentrate is hydrated in water for 30 min at 60° C. It should be appreciated that instead of beginning with dried protein concentrate, the hydrated protein concentrate could have been prepared by mixing dried/wet calcium-depleted MPC and WPC (for example, wet calcium-depleted MPC and dry WPC or dry calcium-depleted MPC and wet WPC or wet calcium-depleted MPC and wet WPC).

Table 15 shows the ingredients used to make a meringue.

TABLE 15
Ingredients for preparing a meringue.

| Ingredients | % w/w | Batch (g) |
|---|---|---|
| Sucrose | 69.05 | 345.23 |
| Water | 23.60 | 118.01 |
| Dry protein concentrate | 7.25 | 36.23 |
| Vanilla | 0.10 | 0.52 |
| Total | 100.00 | 500.00 |

The process for manufacturing the high protein marshmallow is as follows.
The protein concentrate is mixed in a Hobart mixer on the highest speed for approximately six minutes until a stiff peak forms.
Sucrose is added gradually during the mixing (after five minutes of mixing).
The mixing speed is reduced to the lowest setting and the vanilla is added to the frappe. This is mixed for one minute and then mixed on high speed for a further three minutes.
Finally, the meringue is piped onto paper lined baking trays and baked for an hour at 100° C.

This example showed the ability of the protein concentrate to form a stable foam that can be piped into a firm structure as a meringue. Also the foam forms a solid structure at high cooking temperature.

### Example 11

### Pavlova

The following example illustrates the use of the protein concentrate of the present invention to produce a pavlova. The protein concentrate is formed as a blend comprising 50% MPC (81% protein; 90% calcium depletion) (81.4 protein), 30% WPC (80% protein) (80.3 whey protein) and 20% WPI (94% protein) (93.5% whey protein).

As a first step, the dried protein concentrate comprising calcium-depleted MPC and WPC is prepared. This dried protein concentrate is hydrated in water for 30 min at 60° C. It should be appreciated that instead of beginning with dried protein concentrate, the hydrated protein concentrate could have been prepared by mixing dried/wet calcium-depleted MPC and WPC (for example, wet calcium-depleted MPC and dry WPC or dry calcium-depleted MPC and wet WPC or wet calcium-depleted MPC and wet WPC).

Table 16 shows the ingredients used to make a pavlova.

TABLE 16
Ingredients for preparing a pavlova.

| Ingredients | % w/w | Batch (g) |
|---|---|---|
| Sucrose | 59.52 | 200.00 |
| Water | 20.36 | 68.40 |
| Corn flour | 13.39 | 45.00 |
| Dry protein concentrate | 6.43 | 21.60 |
| Vanilla | 0.30 | 1.00 |
| Total | 100.00 | 336.00 |

The process for manufacturing the high protein marshmallow is as follows.
The protein concentrate is mixed in a Hobart mixer on the highest speed for approximately five minutes until a stiff peak forms.
Sucrose is added gradually during the mixing (after five minutes of mixing).
The mixing speed is reduced to the lowest setting and the vanilla and cornflour is added to the frappe. This is mixed for one minute and then mixed on high speed for a further minute.
Finally, put greased paper on a tray and bake the mixture at 150° C. for 45 minutes.

The foam forms a solid but light structure at high cooking temperature.

### Example 12

### Milk Shake

The following example illustrates the use of the protein concentrate of the present invention to produce a milk shake. The protein concentrate is formed as a blend comprising 50% MPC (81% protein; 90% calcium depletion) (81.4 protein), 30% WPC (80% protein) (80.3 whey protein) and 20% WPI (94% protein) (93.5% whey protein).

Table 17 shows the ingredients used to make a milk shake.

TABLE 17
Ingredients for preparing a milk shake.

| Ingredients | % w/w | Batch (g) |
|---|---|---|
| Full cream liquid milk | 89.51 | 290 |
| Sucrose | 10.19 | 33 |
| Dry protein concentrate | 0.31 | 1 |
| Total | 100.00 | 324 |

The process for manufacturing the milk shake is as follows.
Castor sugar is dry blended with the protein concentrate.
The dry blended ingredients are added to 290 mL of full cream milk and mixed in a milk shake maker (Roband milk shake maker) for 1 minute.
The product is then ready to serve at a chilled temperature.

In this example the volume of froth was more than a milkshake with only liquid milk. The froth was stable even without any added stabilisers, i.e. did not collapse or decrease in volume for 10 minutes.

### Example 13

### Whipped Yoghurt

The following example illustrates the use of the protein concentrate of the present invention to produce a whipped yoghurt. The protein concentrate is formed as a blend comprising 50% MPC (81% protein; 90% calcium depletion) (81.4 protein), 30% WPC (80% protein) (80.3 whey protein) and 20% WPI (94% protein) (93.5% whey protein).

As a first step, the dried protein concentrate comprising calcium-depleted MPC and WPC is prepared. This dried protein concentrate is hydrated in water for 30 min at 60° C. It should be appreciated that instead of beginning with dried protein concentrate, the hydrated protein concentrate could have been prepared by mixing dried/wet calcium-depleted MPC and WPC (for example, wet calcium-depleted MPC and dry WPC or dry calcium-depleted MPC and wet WPC or wet calcium-depleted MPC and wet WPC).

Table 18 shows the ingredients used to make a whipped yoghurt.

TABLE 18
Ingredients for preparing a whipped yoghurt.

| Ingredients | % | Weight (g) |
|---|---|---|
| Unsweetened plain yoghurt | 50 | 150 |
| Water | 38 | 114 |
| Dry protein concentrate | 12 | 36 |
| Total | 100 | 300 |

The process for manufacturing the whipped yoghurt is as follows.
The protein solution is mixed at high speed in a Hobart mixer for five minutes.
The unsweetened plain yoghurt is slowly added into the protein frappe and mixing is continued for two minutes.
The product is then ready to serve.

This example gave a light aerated yoghurt. The final product was tested to have a pH of 4.

### Example 14

### High Whey Nougat

The following example illustrates the use of the protein concentrate (mixture of calcium-depleted casein and whey protein) of the present invention to produce a high whey nougat. The protein concentrate is formed as a blend comprising 50% calcium-depleted MPC (80.5 protein), 30% WPC (80.3 whey protein) and 20% WPI (93.5% whey protein). The protein concentrate has a protein content of 83% and 87.4% on a dry basis.

As a first step, the dried protein concentrate comprising the calcium-depleted MPC and WPC is prepared.

Table 19 shows the ingredients used to make a whipped yoghurt.

TABLE 19
Ingredients for preparing a whipped yoghurt.

| Ingredients | % | Weight (g) |
|---|---|---|
| Calcium-depleted casein and whey protein | 4.2 | 169.5 |
| mix (protein concentrate) | | |
| Water | 6.8 | 270.4 |
| Glycerine BP 99.5% liquid | 15.0 | 600.2 |
| Malt extract | 6.3 | 250.1 |
| Glucose syrup | 30.9 | 1236.0 |
| Whey Protein Concentrate | 33.0 | 1320.00 |
| Cocoa powder | 1.3 | 50.0 |
| Palm kernel oil | 2.5 | 100.0 |
| Lecithin | 0.1 | 2.0 |
| Total | 100 | 4000 |

The process for manufacturing the high whey nougat is as follows.
The liquids (glucose syrup, water and malt extract) are heated to 95° C.
The milk protein concentrate is added to the heated liquids.
The mixture is whisked at maximum speed for 7 minutes until smooth stiff peaks are formed.
The palm kernel oil and lecithin are heated on low heat (˜50° C.) and mixed.
The WPI and cocoa powder are gradually added and mixed. Alternately, the melted palm kernel oil and lecithin is added and mixed on low speed until blended.
The mixture is poured onto a tray and left to set at room temperature.

This example gave a high whey nougat.

### INDUSTRIAL APPLICABILITY

The present invention provides concentrates and foams suitable for use in the preparation of foods, and particularly as substitutes for foaming ingredients such as egg white.

Where in the foregoing description reference has been made to elements or integers having known equivalents, then such equivalents are included as if they were individually set forth.

Although the invention has been described by way of example and with reference to particular embodiments, it is to be understood that modifications and/or improvements may be made without departing from the scope or spirit of the invention.

We claim:

1. A foamable composition that comprises calcium-depleted casein and whey protein, and wherein the foamable composition can be whipped to produce a foam having (a) good foaming properties, (b) good heat set properties, or (c) good foaming and heat set properties.

2. A foamable composition comprising between about 1 to about 25% w/w protein, wherein the foamable composition comprises calcium-depleted casein and whey protein, and wherein the foamable composition can be whipped to produce a foam having (a) good foaming properties, (b) good heat set properties, or (c) good foaming and heat set properties.

3. A foamable composition of claim 1 wherein the calcium-depleted casein is a calcium-depleted milk protein concentrate.

4. A foamable composition of claim 1 wherein the calcium-depleted casein is a calcium-depleted caseinate.

5. A foamable composition of claim 1 wherein the whey protein comprises whey protein concentrate or whey protein isolate or a combination thereof.

6. A foamable composition of claim 1 wherein additional whey protein is added to the foamable composition.

7. A foamable composition of claim 1 wherein the foamable composition is a liquid.

8. A foamable composition of claim 1 wherein the foamable composition is a powder.

9. A foamable composition of claim 1 wherein the foamable composition is a solid.

10. A foamable composition of claim 1 wherein the ratio of the calcium-depleted casein to whey protein concentrate in the foamable composition is about 3:1, 3:1.5, 3:2, 3:2.5, 3:3, 2.5:3, 2:3, 1.5:3 or 1:3.

11. A foamable composition of claim 1 wherein the foamable composition comprises about 15, 16, 17, 18, 19, 20, 21, 22, 23, 24 or 25% w/w total protein.

12. A foamable composition of claim 1 wherein the foamable composition comprises about 25, 30, 35, 40, 45, 50, 55, 60, 65, 70 or 75% calcium-depleted casein per total protein.

13. A foamable composition of claim 1 wherein the foamable composition comprises about 25, 30, 35, 40, 45, 50, 55, 60, 65, 70 or 75% whey protein concentrate per total protein.

14. A foamable composition of claim 1 wherein the foamable composition includes any one or more of the following additives:
carbohydrate,
carbohydrate syrup,
salt,
flavour,
thickener,
acid,
alkali,
stabiliser, and
gum.

15. Another aspect of the invention relates to a method of making a foam comprising the steps of
(a) providing calcium-depleted casein and whey protein,
(b) mixing the calcium-depleted casein and whey protein, and
(c) whipping the mixture
wherein a source of water is added to the calcium-depleted casein or the whey protein or is added to the mixture prior to, or during, being whipped.

16. A method of making a foam comprising the steps of
(a) mixing calcium-depleted casein, whey protein and a source of water so that the protein is present at between about 1 to 25% w/w protein, and
(b) whipping the mixture to a foam.

17. A method of claim 15 wherein the protein mixture is whipped using high shear force.

18. A method of claim 15 wherein the calcium-depleted casein and whey protein are dry blended prior to mixing with water and whipping.

19. A method of claim 15 wherein the calcium-depleted casein is at least partially hydrated prior to mixing with dry whey protein.

20. A method of claim 15 wherein the whey protein is at least partially hydrated prior to mixing with dry calcium-depleted casein.

21. A method of claim 15 wherein the calcium-depleted casein and whey protein are wet blended prior to whipping, or prior to the addition of further water and whipping.

22. A method of claim 15 wherein the mixture is partially hydrated, for example when the mixture is formed from a wet/dry mix of hydrated calcium-depleted casein, or of hydrated whey protein, or both hydrated a calcium-depleted casein and whey protein, the hydrated or partially hydrated mixture is dried prior to the hydration step and subsequent whipping.

23. A method of claim 15 wherein the protein is hydrated for about 15, 20, 25, 30, 35, 40, 45, 50, 55, or 60 min.

24. A method of claim 15 wherein the protein is hydrated at about 20, 25, 30, 35, 40, 45, 50, 55 or 60° C.

25. A method of claim 15 wherein the protein is whipped with high shear force for 3, 4, 5, 6 7, 8, 9, or 10 min.

26. A method of claim 15 wherein the whipped protein has high volume.

27. A method of claim 15 wherein the whipped protein has high viscosity.

28. A method of claim 15 wherein the whipped protein has high stability.

29. A method of making a food product comprising the steps of
providing a protein concentrate that comprises calcium-depleted casein and whey protein,
mixing a heated sugar syrup substantially free of sucrose with the protein concentrate,
whipping the mixture, and
wherein the food product has a nougat-like texture with minimal crystallisation.

30. A method of claim 29 wherein the food product is a nougat or nutritional bar.

31. A method of claim 29 wherein the sugar syrup comprises a non-sucrose sugar and glycerine.

32. A method of claim 31 wherein the non-sucrose sugar is glucose.

33. A method of claim 32 wherein the ratio of glucose to glycerine is from about 1:1 to about 8:1 glucose to glycerine.

34. A method of claim 29 wherein the syrup is heated to about at least 60, 65, 70, 75, 80, 85, 90 or 95° C.

35. A food product comprising a foamable composition as claimed in claim 1.

36. A food product of claim 35 wherein the food product is a confectionary or a baked good.

37. A kit comprising calcium-depleted casein and whey protein, wherein the kit provides instructions to
(a) mix the calcium-depleted casein, whey protein and a source of water, and
(b) whip to a foam.
